(19) United States
(12) Patent Application Publication
(10) Pub. No.: US 2015/0184841 A1
(43) Pub. Date: Jul. 2, 2015

(54) TRACK LIGHTING FIXTURE

(71) Applicant: DIODE-ON OPTOELECTRICONICS LIMITED, Taichung City (TW)

(72) Inventor: Ivan Liu, Taichung City (TW)

(73) Assignee: DIODE-ON OPTOELECTRICONICS LIMITED, Taichung City (TW)

(21) Appl. No.: 14/142,159

(22) Filed: Dec. 27, 2013

(51) Int. Cl. F21V 21/34; F21V 29/00; F21S 8/00

(52) U.S. Cl. CPC F21V 21/34; F21S 8/038; F21V 29/2206; F21Y 2101/02

(57) ABSTRACT

A track lighting fixture includes a rail unit, a slidable module, a rotatable module, and a lighting device. The slidable module is mounted on and is movable along the rail unit. The rotatable module is rotatably mounted to the slidable module and is rotatable about a rotation axis perpendicular to the rail unit. The lighting device is pivotably mounted to the rotatable module, is pivotable about a pivot axis that is perpendicular to the rotation axis, and includes a shade and at least one lighting element. The shade is pivotably mounted to the rotatable module, and the lighting element is disposed in the shade.

### BACKGROUND OF THE INVENTION

1. Field of the Invention

The invention relates to a lighting fixture, more particularly to a track lighting fixture.

2. Description of the Related Art

A conventional lighting fixture is usually mounted at four corners of a display cabinet to illuminate an article disposed in the display cabinet. However, range and orientation of illumination area of the conventional lighting fixture are limited by its mounting position. For example, when the article disposed in the display cabinet has a different size or is placed at a different position, it cannot be illuminated properly due to the limited range and orientation of the illumination area attributed to the position of the conventional lighting fixture. Further, light emitted from the conventional lighting fixture usually diffuses, which adversely affects the illumination effect.

### SUMMARY OF THE INVENTION

The object of the present invention is to provide a track lighting fixture capable of providing adjustable range and orientation of illumination direction and a relatively condensed illumination effect.

According to the present invention, there is provided a track lighting fixture including a rail unit, a slidable module, a rotatable module, and a lighting device. The slidable module is mounted on and is movable along the rail unit. The rotatable module is rotatably mounted to the slidable module and is rotatable about a rotation axis perpendicular to the rail unit. The lighting device is pivotably mounted to the rotatable module, is pivotable about a pivot axis that is perpendicular to the rotation axis, and includes a shade and at least one lighting element. The shade is pivotably mounted to the rotatable module, and the lighting element is disposed in the shade.

Preferably, the lighting device further includes a light condensing element disposed in the shade and registered with the lighting element for condensing light emitted from the lighting element.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a preferred embodiment of a track lighting fixture according to the present invention;

FIG. 2 is an exploded perspective view of the preferred embodiment;

FIG. 3 is a cross-sectional view taken along line III-III in FIG. 1, illustrating relationships among components of the track lighting fixture in detail;

FIG. 4 is a fragmentary schematic bottom view of a rail unit of the track lighting fixture;

FIG. 5 is a fragmentary schematic bottom view of the preferred embodiment, illustrating a limiting protrusion opposite to a protuberance of the track lighting fixture;

FIG. 6 is another fragmentary schematic bottom view of the preferred embodiment, illustrating the limiting protrusion in contact with the protuberance; and

FIG. 7 is a cross-sectional view of the preferred embodiment, illustrating a way to attach a slidable module of the track lighting fixture to the rail unit.

### DETAILED DESCRIPTION OF THE PREFERRED EMBODIMENT

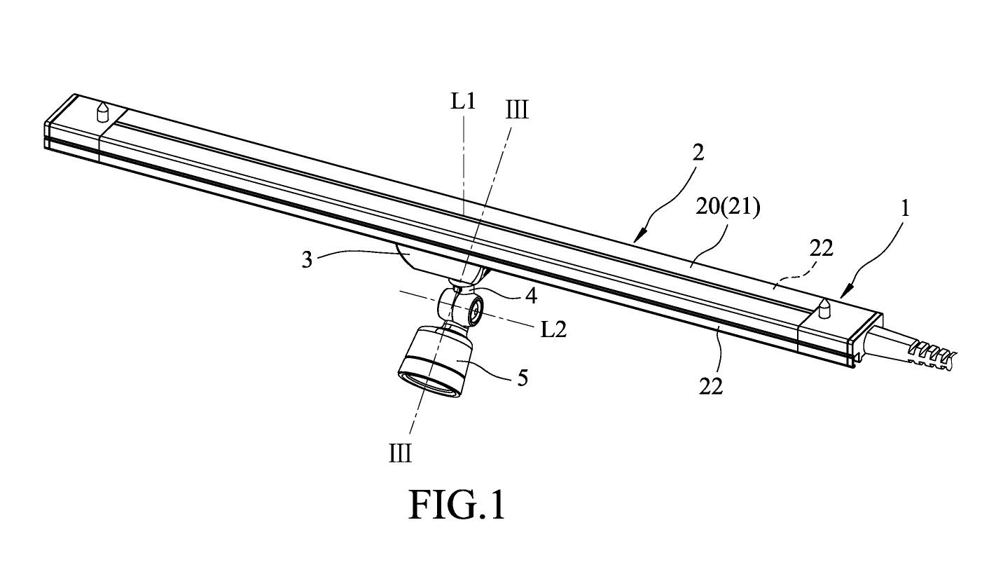

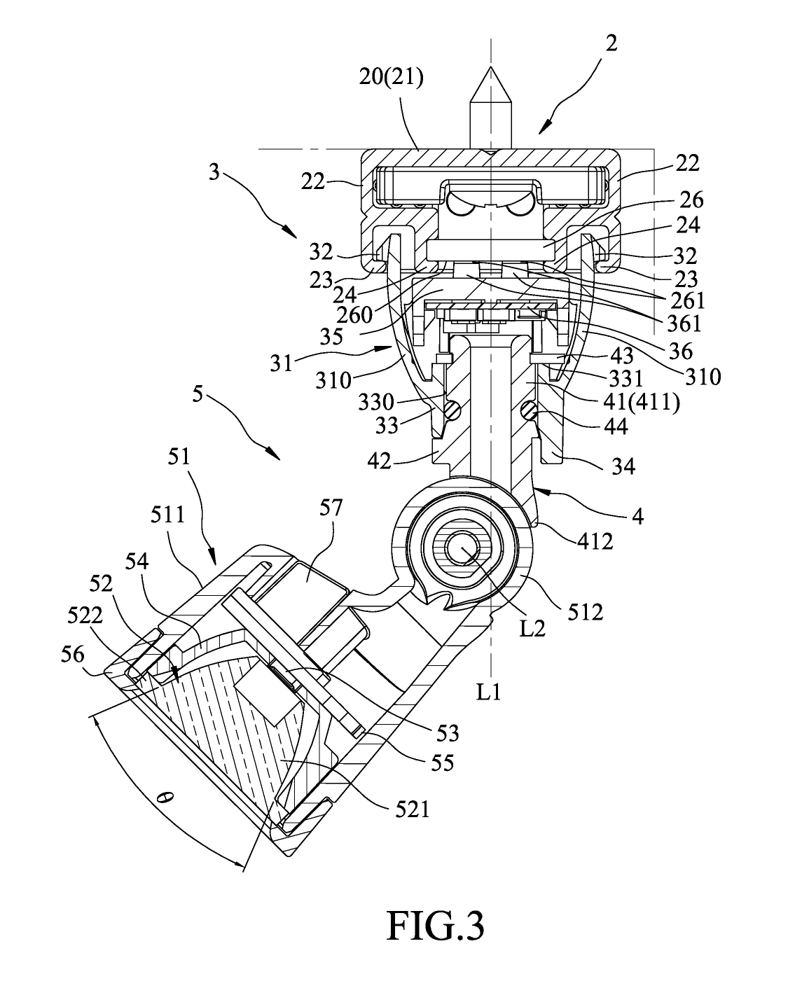

Referring to FIGS. 1 to 4, the preferred embodiment of the track lighting fixture 1 according to the present invention is shown to include a rail unit 2, a slidable module 3, a rotatable module 4, and a lighting device 5.

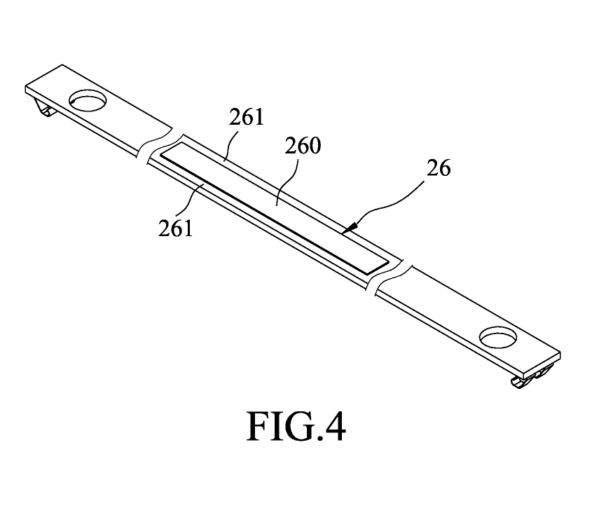

The rail unit 2 includes a rail 20 and a power supply circuit board 26. The rail 20 includes a top wall 21, two side walls 22, two guiding flanges 23, and two mounting protrusions 24. The side walls 22 extend respectively and downwardly from opposite sides of the top wall 21. Each of the guiding flanges 23 extends from a lowermost end of a respective one of the side walls 22 toward the other one of the side walls 22. The mounting protrusions 24 extend inwardly and respectively from the side walls 22 toward each other for mounting of the power supply circuit board 26. The power supply circuit board 26 is suspended on the mounting protrusions 24, and has a bottom surface 260 provided with a pair of elongated electrodes 261 (see FIG. 4). The electrodes 261 extend along the rail unit 2, and are spaced apart from each other in a direction perpendicular to an extension direction of the rail unit 2. Note that while the rail 20 is integrally formed by aluminum extrusion, the invention is not limited in this respect. The electrodes 261 are made of a metal material, are electrically connected to a power socket (not shown) via a transformer (not shown), and serve as an anode and a cathode, respectively.

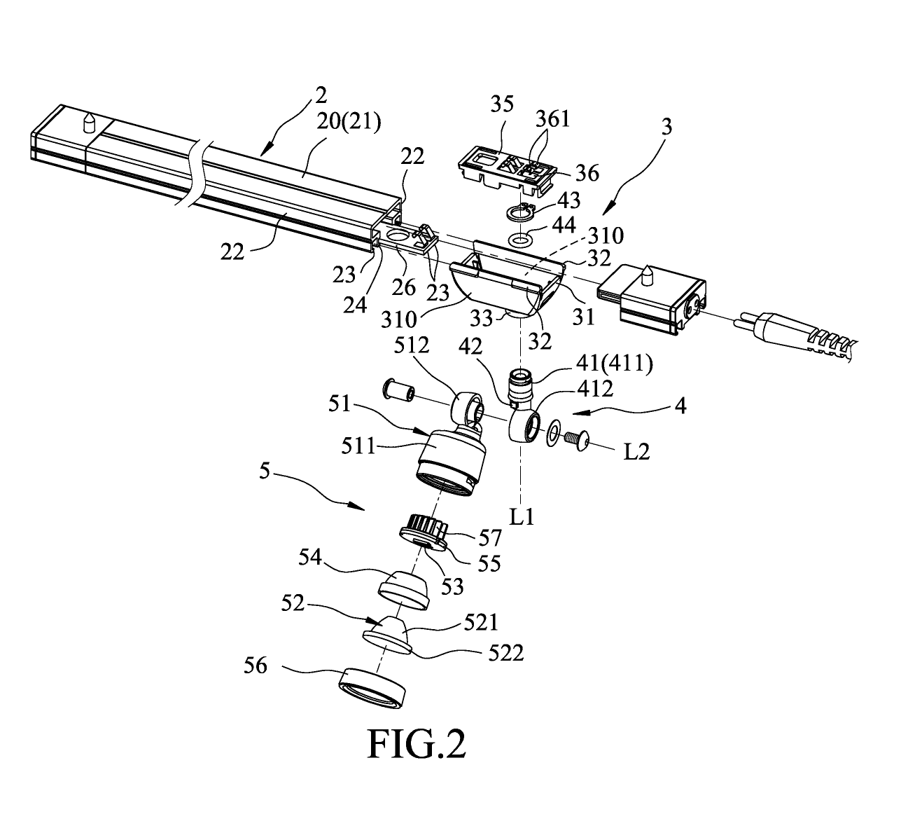

The slidable module 3 includes a housing 31, two pairs of hooks 32 (only three are visible in FIG. 2 due to the viewing angle), a tubular wall 33, a limiting protrusion 34, a mounting seat 35, and a slidable circuit board 36.

For each pair, the hooks 32 extend from one of two opposite sides 310 of the housing 31 toward a corresponding one of the guiding flanges 23 of the rail 20, are spaced apart from each other in the extension direction, engage the corresponding one of the guiding flanges 23, and are slidable relative to the rail unit 2. The housing 31 of the slidable module 3 has a bottom end. The tubular wall 33 is disposed at the bottom end of the housing 31, extends along a rotation axis (L1) perpendicular to the rail unit 2, and defines a mounting hole 330. The limiting protrusion 34 extends from the tubular wall 33 along the rotation axis (L1) away from the housing 31. The mounting seat 35 is disposed in the housing 31. The slidable circuit board 36 is mounted on the mounting seat 35, and includes two pairs of contacting electrodes 361 in sliding contact with the elongated electrodes 261, respectively. Note that the number of the contacting electrodes 361 may be different in other embodiments of this invention. Additionally, the slidable circuit board 36 may include a bridge rectifier (not shown), such that the mounting seat 35 is relatively compatible with the elongated electrodes 261 regardless of which one of the contacting electrodes 361 being in electrical contact with either the anode or the cathode.

The rotatable module 4 includes a rotatable shaft 41, a protuberance 42, a C-ring 43 and an O-ring 44. The rotatable shaft 41 includes an inserted segment 411 and a joining segment 412. The inserted segment 411 is inserted into the mounting hole 330, extends along the rotation axis (L1), and is inserted rotatably into the tubular wall 33 about the rotation axis (L1). The joining segment 412 extends from the inserted segment 411 away from the tubular wall 33, and extends along a pivot axis (L2) perpendicular to the rotation axis (L1).

The protuberance 42 extends perpendicularly from the rotatable shaft 41 outwardly of the tubular wall 33. The tubular wall 33 has a top end 331, and the C-ring 43 clamps the inserted segment 411 of the rotatable shaft 41, and abuts against the top end 331 of the tubular wall 33. The O-ring 44 is sleeved on the inserted segment 411, and is disposed between the inserted segment 411 and the tubular wall 33. By this way, friction between the inserted segment 411 and the tubular wall 33 is increased, and undesired movement of the rotatable shaft 411 can be alleviated when the lighting device 5 encounters accidentally impact.

The lighting device 5 includes a shade 51, a light condensing element 52, a lighting element 53, a light reflecting element 54, a lighting-device circuit board 55, an end cap 56, and a plurality of heat dissipating fins 57.

The shade 51 includes a hollow body 511 receiving the lighting element 53 therein, and a linking portion 512 that is connected to the hollow body 511 and that is pivoted to the joining segment 412 about the pivot axis (L2), such that the lighting device 5 is pivotable about the pivot axis (L2) relative to the joining segment 412. In this embodiment, the lighting element 53 is a light-emitting diode (LED). The light condensing element 52 has a frustoconical configuration, is disposed in the hollow body 511 of the shade 51, and is registered with the lighting element 53 for condensing light emitted from the lighting element 53. The light condensing element 52 includes a main portion 521 adjacent to the lighting element 53, and a collar portion 522 extending outwardly and radially from a periphery of the main portion 521 opposite to the lighting element 53.

The light reflecting element 54 is disposed between the light condensing element 52 and the hollow body 511 of the shade 51, and the collar portion 522 extends beyond the light reflecting element 54. The end cap 56 is attached to an open end of the shade 51, and abuts against the collar portion 522 so as to prevent removal of the light condensing and reflecting elements 52, 54 from the shade 51.

The light condensing element 52 is configured to condense light emitted from the lighting element 53 and reflected by the light reflecting element 54 to obtain a light beam having a beam angle ranging from 5° to 60°. It is noted that the beam angle may vary according to configuration of the light condensing element 52. By virtue of the end cap 56, it is relatively convenient to replace the light condensing element 52 when a different beam angle of the light beam is desired.

The lighting-device circuit board 55 is disposed in the shade 51, and is electrically connected to the lighting element 53 and the elongated electrodes 261 through the contacting electrodes 361. The heat dissipating fins 57 are mounted on the lighting-device circuit board 55 opposite to the lighting element 53 for dissipating heat generated by the lighting-device circuit board 55 and the lighting element 53.

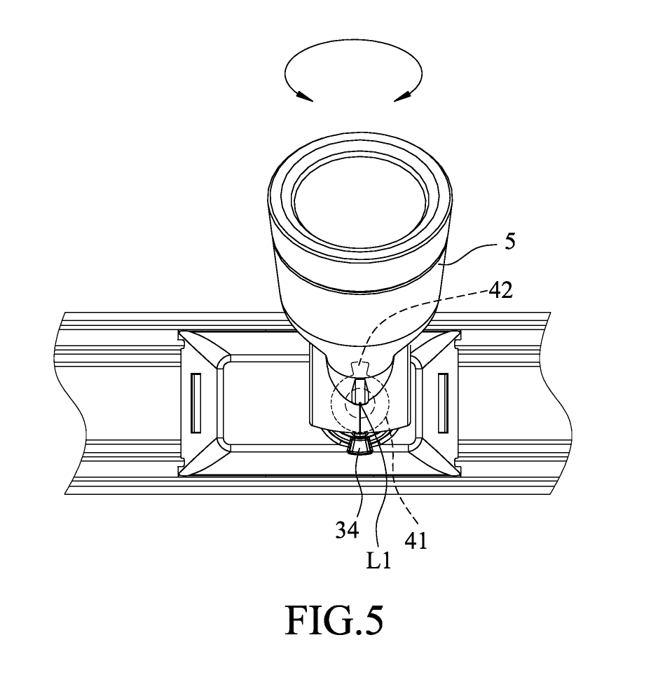

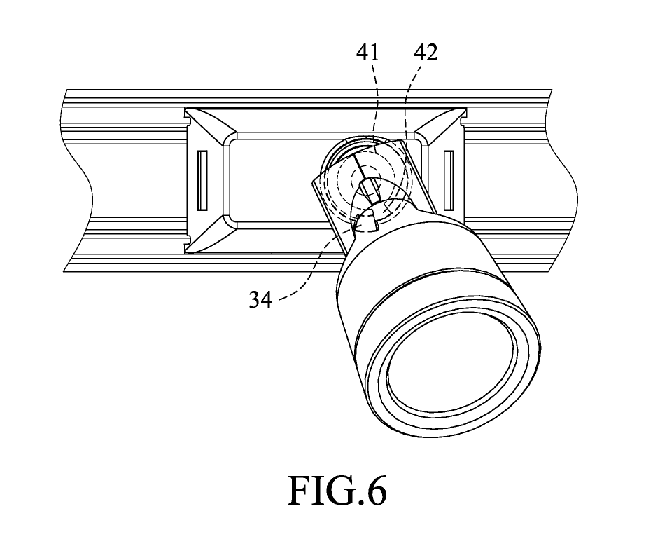

To adjust illumination direction of the lighting device 5, as shown in FIG. 5, the rotatable shaft 41 can be rotated about the rotation axis (L1) as indicated by arrows shown in FIG. 5. At this position, the protuberance 42 is away from the limiting protrusion 34. Further referring to FIG. 6, when the protuberance 42 makes contact with the limiting protrusion 34, rotation of the rotatable shaft 41 is arrested. Note that an included angle between two imaginary lines extending respectively through two opposite surfaces of the limiting protrusion 34 that are configured to MAKE contact with the protuberance 42 is about 60°, and thus, a rotation angle of the rotatable shaft 41 ranges from 0° to 300°.

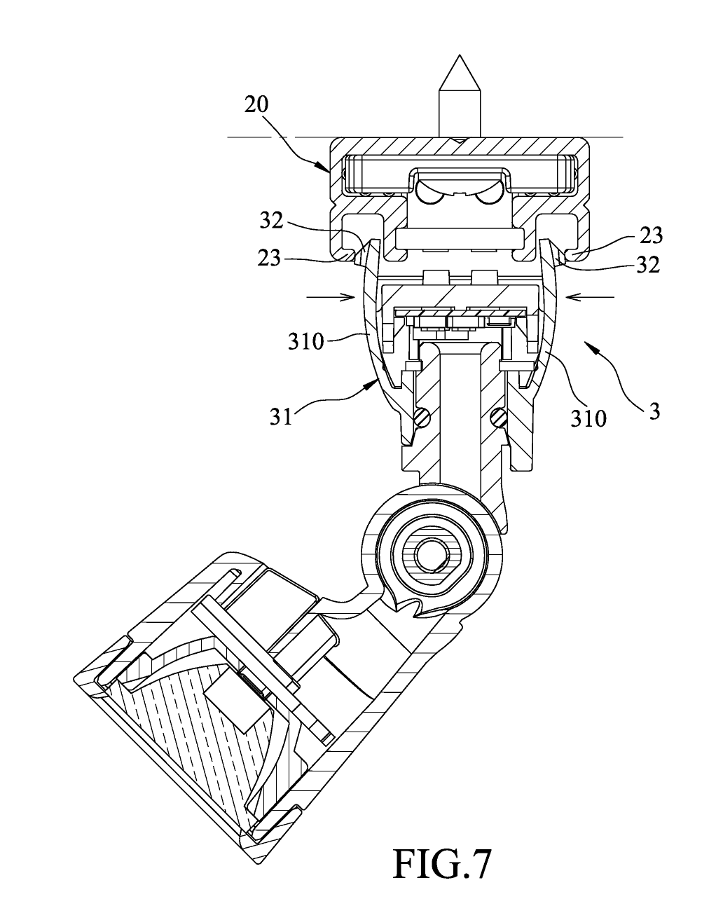

As shown in FIG. 7, to attach the slidable module 3 to the rail 20, a force is exerted on the housing 31 to inwardly press the housing 31 in directions shown in FIG. 6, such that the opposite sides 310 of the housing 31 are resiliently deformed toward each other and then the hooks 32 are snapped into the rail 20 to engage the guiding flanges 23.

To sum up, by virtue of the slidable module 3 and the rotatable module 4, the lighting device 5 can move along the rail unit 2 and can be rotated about the rotation axis (L1) and pivoted about the pivot axis (L2). Accordingly, the illumination direction of the lighting device 5 can be adjusted widely. Further, light emitted from the lighting element 53 can be condensed by the light condensing element 52 so as to provide condensed illumination. Additionally, it is relatively simple to replace the light condensing element 52 when desired by removing the end cap 56. Finally, configurations of the hooks 32 and the guiding flanges 23 make it easy to attach and detach the slidable module 3 to the rail unit 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A track lighting fixture comprising:
a rail unit;
a slidable module mounted on said rail unit and movable along said rail unit;
a rotatable module rotatably mounted to said slidable module and rotatable about a rotation axis that is perpendicular to said rail unit; and
a lighting device pivotably mounted to said rotatable module and pivotable about a pivot axis that is perpendicular to the rotation axis, and including
a shade pivotably mounted to said rotatable module, and
at least one lighting element that is disposed in said shade.

2. The track lighting fixture as claimed in claim 1, wherein said rail unit includes:
a top wall;
two side walls extending respectively and downwardly from opposite sides of said top wall; and
two guiding flanges each extending from a lowermost end of a respective one of said side walls toward the other one of said side rails,
said slidable module including
a housing, and
at least two hooks that extend from said housing away from each other respectively toward said guiding flanges, that engage said guiding flanges, respectively, and that are movable relative to said rail unit.

3. The track lighting fixture as claimed in claim 2, wherein:
said housing of said slidable module has a bottom end;
said slidable module further includes
a tubular wall that is disposed at said bottom end of said housing, that extends along the rotation axis and that defines a mounting hole, and
a limiting protrusion extending from said tubular wall along the rotation axis away from said housing; and
said rotatable module includes
a rotatable shaft inserted into said mounting hole and rotatable about the rotation axis relative to said tubular wall, and
a protuberance extending from said rotatable shaft outwardly of said tubular wall in a manner that said limiting protrusion arrests rotation of said rotatable shaft when said protuberance makes contact with said limiting protrusion during rotation of said rotatable shaft.

4. The track lighting fixture as claimed in claim 3, wherein:
said rotatable shaft includes an inserted segment that is inserted into said mounting hole and that extends along the rotation axis, and a joining segment that extends from said inserted segment away from said tubular wall and that extends along the pivot axis; and
said shade of said lighting device includes a hollow body that receives said lighting element therein, and a linking portion that is connected to said hollow body, and that is pivoted to said joining segment along the pivot axis such that said lighting device is pivotable about the pivot axis relative to said joining segment.

5. The track lighting fixture as claimed in claim 4, wherein said tubular wall has a top end, and said rotatable module further includes a C-ring clamping said inserted segment of said rotatable shaft and abutting against said top end of said tubular wall.

6. The track lighting fixture as claimed in claim 4, wherein said rotatable module further includes an O-ring sleeved on said inserted segment of said rotatable shaft and disposed between said inserted segment and said tubular wall.

7. The track lighting fixture as claimed in claim 2, wherein said rail unit further includes two mounting protrusions extending inwardly and respectively from said side walls toward each other, and a power supply circuit board suspended on said mounting protrusions and including a pair of elongated electrodes that extend along said rail unit, that are spaced apart from each other, and that are electrically connected to said lighting element.

8. The track lighting fixture as claimed in claim 7, wherein said slidable module further includes a mounting seat disposed in said housing and a slidable circuit board mounted on said mounting seat and including two contacting electrodes that are in sliding contact with said elongated electrodes, respectively, and that are electrically connected to said lighting element.

9. The track lighting fixture as claimed in claim 1, wherein said lighting device further includes a light condensing element disposed in said shade and registered with said lighting element for condensing light emitted from said lighting element.

10. The track lighting fixture as claimed in claim 9, wherein said light condensing element includes a main portion adjacent to said lighting element, and a collar portion that extends outwardly and radially from a periphery of said main portion opposite to said lighting element, said lighting device further including:
a light reflecting element that is disposed between said light condensing element and said shade and beyond which said collar portion extends, and
an end cap that is attached to an open end of said shade and that abuts against said collar portion so as to prevent removal of said light condensing element and said light reflecting element from said shade.

11. The track lighting fixture as claimed in claim 9, wherein said light condensing element has a frustoconical configuration.

12. The track lighting fixture as claimed in claim 10, wherein said light condensing element is configured to condense the light emitted from said lighting element and reflected by said light reflecting element to a light beam having a beam angle ranging from 5° to 60°.

13. The track lighting fixture as claimed in claim 1, wherein said lighting device further includes a lighting-device circuit board disposed in said shade and electrically connected to said lighting element, and at least one heat dissipating fin mounted on said lighting-device circuit board opposite to said lighting element for dissipating heat generated by said lighting-device circuit board and said lighting element.

14. The track lighting fixture as claimed in claim 1, wherein said lighting element is a light emitting diode.
